(19) United States
(12) Patent Application Publication
(10) Pub. No.: US 2012/0081688 A1
(43) Pub. Date: Apr. 5, 2012

(54) APPARATUS AND METHOD FOR PREPARING LENTICULAR SHEET

(75) Inventor: Hiroyuki YAMAJI, Osaka (JP)

(73) Assignee: SHARP KABUSHIKI KAISHA, Osaka (JP)

(21) Appl. No.: 13/239,550

(22) Filed: Sep. 22, 2011

(30) Foreign Application Priority Data
Sep. 30, 2010 (JP) 2010-222341

(51) Int. Cl. G03B 27/32

(52) U.S. Cl. 355/77

(57) ABSTRACT

An apparatus for preparing a lenticular sheet includes a photoconductor, a light emitting section for forming an electrostatic latent image on the photoconductor, a developing section for forming a transparent toner layer by applying a transparent toner to the electrostatic latent image on the photoconductor, a transferring section for transferring the transparent toner layer on a transparent sheet and a lens forming section for forming a lenticular lens by molding and fixing the transferred transparent toner layer on the transparent sheet.

### CROSS-REFERENCE TO RELATED APPLICATION

This application relates to Japanese Patent Application No. 2010-222341 filed on Sep. 30, 2010, whose priority is claimed and the disclosure of which is incorporated by reference in its entirety.

### BACKGROUND OF THE INVENTION

1. Field of the Invention

The present invention relates to an apparatus and a method for preparing a lenticular sheet used for displaying a three-dimensional stereoscopic image.

2. Description of the Related Art

An electrophotographic type image forming apparatus is capable of forming an image of high quality with excellent reproducibility and operability, in a cost-effective manner. Therefore, this image forming apparatus is used as a copier, a printer, a facsimile machine, a multi function peripheral possessing the functions of at least two of them, or the like.

Meanwhile, a lenticular sheet is made of an array of elongated miniature semicylindrical convex lenses (lenticular lens) which are disposed to be sheet-like on a surface of a transparent sheet. By the refraction of each convex lens of the lenticular lens, lenticular images (in which at least two images are divided in a strip-like manner and aligned alternately in accordance with a pitch of the lenticular lens) printed on the back surface of the lenticular sheet are switched depending on the viewing angle. Use of such a lenticular sheet makes it possible to switch a plurality of images by changing the viewing angle. In particular, since it realizes production of a stereoscopic image using a parallax between the right and left eyes without the necessity of using any special device such as 3D glasses and the like, such a lenticular sheet is widely used for posters, signboards and the like.

A transparent sheet used as such an apparatus for preparing a lenticular sheet may include a paper, a plastic film, a sheet and the like. An example of a preparing method of such a lenticular sheet is a method using a transparent sheet exhibiting translucency, which includes: a thermoplastic resin layer on one side thereof for forming a lenticular lens; and a thermoplastic image receiving layer on the other side thereof for forming an image with a toner. According to this method, by forming lenses at the resin layer for forming the lenticular lens after an image is formed with the toner, an image having a lens layer on its surface is obtained (e.g., see Japanese Unexamined Patent Application Publication No. 2008-26477).

However, in accordance with the conventional method, while an electrophotographic system is used in forming an image with the toner, another step such as a hot press through the use of a molding assembly for forming the lenticular lens is included. Therefore, a preparing apparatus is separately required. Accordingly, there is a demand for an apparatus and a method for preparing a lenticular sheet, with which a series of steps from forming the transparent toner layer to forming the lenticular lens can entirely be performed with the electrophotographic system, which consequently realizes the preparation with a single apparatus with ease.

### SUMMARY OF THE INVENTION

The present invention has been made in consideration of the problems in the conventional apparatus and method described above, and an object thereof is to provide an apparatus and a method for preparing a lenticular sheet, with which a series of steps from forming the transparent toner layer to forming the lenticular lens can entirely be performed with the electrophotographic system, and which consequently realizes the preparation with a single apparatus with ease.

The present invention provides an apparatus for preparing a lenticular sheet that includes: a photoconductor; a light emitting section for forming an electrostatic latent image on the photoconductor; a developing section for forming a transparent toner layer by applying a transparent toner to the electrostatic latent image on the photoconductor; a transferring section for transferring the transparent toner layer on a transparent sheet; and a lens forming section for forming a lenticular lens by molding and fixing the transferred transparent toner layer on the transparent sheet.

The present invention provides a method for preparing a lenticular sheet that includes the steps of: forming an electrostatic latent image on a photoconductor; forming a transparent toner layer by applying a transparent toner to the electrostatic latent image on the photoconductor; transferring the transparent toner layer on a transparent sheet; and forming a lenticular lens by molding and fixing the transferred transparent toner layer on the transparent sheet.

With the apparatus and method for preparing the lenticular sheet of the present invention, a series of steps from forming the transparent toner layer to forming the lenticular lens is entirely performed with the electrophotographic system. Thus, an apparatus and a method for preparing a lenticular sheet which preparation can be achieved with a single apparatus with ease can be realized.

Further, use of the electrophotographic system which is a commonly-used technique in the field of image forming apparatuses makes it possible to realize an apparatus and a method for preparing a lenticular sheet which operates stably with high-reliability.

### BRIEF DESCRIPTION OF THE DRAWINGS

FIG. 1 is an explanatory diagram showing the structure of an apparatus for preparing a lenticular sheet according to a first embodiment of the present invention;

FIG. 2 is a cross-sectional view showing the structure of a lens forming section according to the first embodiment of the present invention;

FIGS. 3(A) and 3(B) are perspective views of chief parts of the lens forming section shown in FIG. 2;

FIGS. 4(A) and 4(B) are explanatory diagrams showing a lens forming roller according to a second embodiment of the present invention;

FIGS. 5(A) and 5(B) show measurement results of a lenticular sheet surface after a lens is formed by the apparatus for preparing a lenticular sheet according to an first and second embodiments of the present invention;

FIGS. 6(A) and 6(B) are explanatory diagrams showing a variation of a web press roller according to the first embodiment of the present invention;

FIG. 7 is a cross-sectional view showing the structure of an apparatus for preparing a lenticular sheet according to a third embodiment of the present invention;

FIGS. 8(A) and 8(B) are perspective views of chief parts of the lens forming section shown in FIG. 7; and

FIGS. 9(A) and 9(B) are explanatory diagrams of a variation of a lens forming belt according to the third embodiment of the present invention.

### DETAILED DESCRIPTION OF THE PREFERRED EMBODIMENTS

An apparatus for preparing a lenticular sheet of the present invention includes: a photoconductor; a light emitting section for forming an electrostatic latent image on the photoconductor; a developing section for forming a transparent toner layer by applying a transparent toner to the electrostatic latent image on the photoconductor; a transferring section for transferring the transparent toner layer on a transparent sheet; and a lens forming section for forming a lenticular lens by molding and fixing the transferred transparent toner layer on the transparent sheet.

A method for preparing a lenticular sheet of the present invention includes: forming an electrostatic latent image on a photoconductor; forming a transparent toner layer by applying a transparent toner to the electrostatic latent image on the photoconductor; transferring the transparent toner layer on the transparent sheet; forming a lenticular lens by molding and fixing the transferred transparent toner layer on the transparent sheet.

In the apparatus for preparing a lenticular sheet of the present invention, the lens forming section may include a lens forming roller heated by an internal heater, the lens forming roller rotating about an axis thereof, and a pressure roller disposed to face the lens forming roller to pressurize the lens forming roller. The lens forming roller may include a plurality of grooves formed on an outer circumferential surface thereof at a prescribed pitch. The pressure roller and the lens forming roller a nip portion therebetween. The transparent sheet may be fed to the nip portion. The lens forming roller may successively press the transparent toner layer with the outer circumferential surface and bring about a heat deformation to form the lenticular lens.

In the method for preparing a lenticular sheet of the present invention, the step for forming a lenticular lens may be accomplished by a lens forming section including a lens forming roller heated by an internal heater, the lens forming roller rotating about an axis thereof, and a pressure roller disposed to face the lens forming roller to pressurize the lens forming roller. The lens forming roller may include a plurality of grooves formed on an outer circumferential surface thereof at a prescribed pitch. The pressure roller and the lens forming roller may form a nip portion therebetween. The transparent sheet may be fed to the nip portion. The lens forming roller may successively press the transparent toner layer with the outer circumferential surface and bring about a heat deformation to form the lenticular lens.

In this manner, by designing the lens forming section to be a roller structure (rotary structure), it becomes possible to reduce the size of the lens forming section.

In the apparatus for preparing a lenticular sheet of the present invention, the lens forming section may include a belt support member with a heater, a belt support roller, an lens forming belt movably suspended between the belt support member and the belt support roller, the lens forming belt heated by the heater, and a pressure roller disposed to face the belt support roller through the lens forming belt. The lens forming belt may include a plurality of grooves formed on an outer circumferential surface thereof at a prescribed pitch. The pressure roller may pressurize the belt support roller and the pressure roller and the belt support roller may form a nip portion therebetween. The transparent sheet may be fed to the nip portion. The lens forming belt may successively press the transparent toner layer with the outer circumferential surface and bring about a heat deformation to form the lenticular lens.

In the method for preparing a lenticular sheet of the present invention, the lens forming step may be accomplished by a lens forming section including a belt support member with a heater, a belt support roller, a lens forming belt movably suspended between the belt support member and the belt support roller, the lens forming belt heated by the heater, and a pressure roller disposed to face the belt support roller through the lens forming belt. The lens forming belt may include a plurality of grooves formed on an outer circumferential surface thereof at a prescribed pitch. The pressure roller may pressurize the belt support roller and the pressure roller and the belt support roller may form a nip portion therebetween. The transparent sheet may be fed to the nip portion, and the lens forming belt may successively press the transparent toner layer with the outer circumferential surface and bring about a heat deformation to form the lenticular lens.

In this manner, by designing the lens forming section to be a belt shape, a heat capacity can be reduced. Further, by the belt support member with the heater, the lens forming belt is heated which enables a quick increase in the temperature, which in turn makes it possible to drastically shorten the warm-up time and the like.

In the apparatus for preparing a lenticular sheet of the present invention, the light emitting section may be configured to form the electrostatic latent image having a size corresponding to a size of the transparent sheet on the photoconductor.

In this manner, an electrostatic latent image corresponding to the size of the transparent sheet is formed, and whereby a region where the transparent toner is to be applied is set in accordance with the size of the transparent sheet. Therefore, a wasteful amount of toner more than needed will not be consumed, and the efficient lenticular sheet preparing apparatus and the efficient lenticular sheet preparing method thereof can be realized.

Further, by setting the electrostatic latent image corresponding to the region where the transparent toner is to be applied while taking into consideration of the transparent toner layer extruded from the transparent sheet by being pressed against the lens forming belt, such an extrusion of the transparent toner from the transparent sheet caused by being pressed can previously be avoided. Accordingly, it becomes possible to realize an apparatus and a method for preparing a lenticular sheet which operate stably with high reliability even in a case where the transparent sheet of a different size is used every time.

Meanwhile, in a case where the size of the transparent sheet is small relative to the lens forming roller length, the transparent toner extruded from the circumference of the transparent sheet by being pressed may adhere to the lens forming roller. When such an offset toner adhered to the molding assembly is left as it is, the effect of the portion which the offset toner adheres to makes the transparent layer thickness distribution nonuniform, when a transparent sheet of a great size is used next time. Thus, it inhibits formation of an excellent lenticular lens. However, the apparatus for preparing a lenticular sheet of the present invention emits light to the photoconductor in accordance with the size of the transparent sheet to form an electrostatic latent image. Therefore, even in a case where a transparent sheet of a different size is used every time, the foregoing problem will not be invited. Accordingly, an apparatus and a method for preparing a lenticular sheet which operate stably with high reliability can be realized.

In the apparatus for preparing a lenticular sheet of the present invention, the grooves may be formed along a feed direction of the transparent sheet.

In this manner, by forming the grooves along a feed direction of the transparent sheet, the elongated transparent sheet is supplied longitudinally with reference to the apparatus for preparing a lenticular sheet. Thus, since the lenticular lens extending along the longitudinal direction of the transparent sheet can easily be formed, the productivity of the lenticular sheet improves. In particular, high-volume production of the lenticular sheet which provides a 3D effect, which is exhibited when the lenticular lens extending along the longitudinal direction of the elongated sheet is viewed from the transverse direction, can easily be achieved.

In the apparatus for preparing a lenticular sheet of the present invention, the grooves may be formed across a feed direction of the transparent sheet.

In this manner, by forming the grooves across a feed direction of the transparent sheet, the elongated transparent sheet is supplied longitudinally with reference to the apparatus for preparing a lenticular sheet. Thus, since the lenticular lens extending along the short side direction of the transparent sheet can easily be formed, the productivity of the lenticular sheet improves. In particular, high-volume production of the lenticular sheet which provides a 3D effect, which is exhibited when the lenticular lens extending along the transverse direction of the elongated sheet is viewed from the longitudinal direction, can easily be achieved.

In particular, in a case where the lens forming belt is used, the outer circumferential length of the lens forming belt can freely be set without being dependent on the diameter of the belt support roller. Therefore, the uniformess of the interval of the grooves over the entire outer circumferential surface of the lens forming belt can easily be secured. Hence, being different from a case where the grooves are formed on the outer circumferential surface of the roller, it is not necessary to design the diameter of the roller such that the outer circumferential length of the roller becomes just an integer multiple of the pitch width of the lenticular lens for the purpose of consistently keeping the interval between adjacent ones of the grooves over the entire circumference constant.

Further, in a case where the lens forming belt is used, by previously preparing a plurality of types of groove patterns differing in pitch from one another in different regions in the circumferential direction of the lens forming belt, and by detecting the position of the feed direction of the lens forming belt, it becomes possible to quickly select and use the region of the groove pattern of the required pitch. Thus, without the necessity of performing a troublesome work of replacing or switching the lens forming section, grooves of a different pitch can be selected, and a lenticular lens of the required pitch can easily be formed.

In the apparatus for preparing a lenticular sheet of the present invention, the transparent toner may contain a mold release agent for preventing adherence to the outer circumferential surface.

In this manner, use of the mold release agent in the transparent toner that prevents adherence to the outer circumferential surface of the lens forming roller or the lens forming belt can implement an apparatus for preparing a lenticular sheet such that occurrence of the offset toner at the lens forming roller is reduced, whereby stable operation lasts for a long term with high reliability.

In the apparatus for preparing a lenticular sheet of the present invention, the outer circumferential surface may include a release layer for preventing adherence of the transparent toner thereto.

In this manner, provision of the transparent toner release layer on the outer circumferential surface of the lens forming roller or the lens forming belt can implement a lenticular sheet preparing apparatus such that occurrence of the offset toner at the lens forming roller is reduced, whereby stable operation lasts for a long term with high reliability. Further, the transparent toner release layer may be formed by applying a transparent toner mold release agent on the outer circumferential surface.

The apparatus for preparing a lenticular sheet of the present invention may further include a cleaning section including a heat resistant web, a web feed roller around which the web is wound and retained, a web press roller disposed to face the lens forming roller or belt through the web, and a web wind roller for winding up the web fed from the web press roller. The cleaning section causes the web to press and slide against the outer circumferential surface of the lens forming roller or belt to remove the transparent toner adhered thereto. The web press roller may have a surface of a shape conforming to the grooves.

In this manner, for example, by forming the web press roller into convex shapes conforming to the grooves of the lens forming roller or belt, it becomes possible to implement an apparatus for preparing a lenticular sheet such that the offset toner adhered to the bottom plane of the grooves at the outer circumferential surface of the lens forming roller or belt can be surely removed, whereby stable operation lasts for a long term with high reliability.

In particular, even in a case where the transparent toner is extruded from the circumference of the transparent sheet by being pressed against the lens forming roller or belt and adhered to the lens forming roller or belt, the offset toner adhered to the lens forming roller or belt can efficiently be removed by the web. Hence, even in a case where transparent sheets differing in size from one another are successively used, no troublesome work, e.g., cleaning after the lens formation, is required, and an apparatus for preparing a lenticular sheet that stably operates with high reliability can be implemented.

A heat resistance nonwoven fabric can be used as the web (fibers) for cleaning. Though the heat resistance nonwoven fabric is not particularly limited, examples thereof include a nonwoven fabric that contains aromatic polyamide fibers and polyester fibers being softened at high temperatures, and that possesses combined features of appropriate flexibility and mechanical strength. Such a heat resistance nonwoven fabric is commercially available. Examples thereof include Nomex (registered trademark), Himelon (registered trademark) and the like. Further, though the thickness of the web is not particularly limited also, it is preferably 30 to 100 μm.

Various preferred examples shown herein can be used in combinations.

In the following, with reference to the drawings, a detailed description will be given of an apparatus and a method for preparing a lenticular sheet according to a first embodiment of the present invention. It is to be noted that, the following description is exemplified in every respect, and should not be construed to be any limitation of the present invention.

It is to be noted that the drawings are schematic, and that proportions of dimensions or the like in the drawings are different from actual ones. Similarly, it is to be noted that proportions of dimensions or the like are different from one another among the drawings. Therefore, specific dimensions or the like should be determined taking into consideration of the following description or the technical common knowledge and the like.

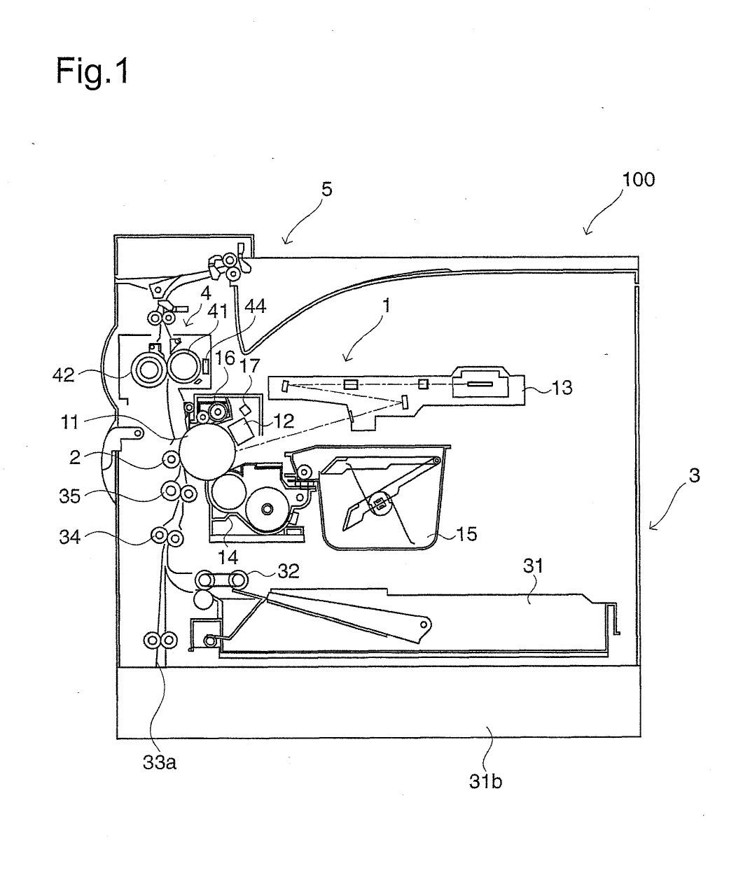

In the following, with reference to FIGS. 1 to 3, a description will be given of an apparatus for preparing a lenticular sheet according to a first embodiment of the present invention.

### <<Structure of Lenticular Sheet Preparing Apparatus>>

FIG. 1 is an explanatory diagram showing the structure of an apparatus for preparing a lenticular sheet according to a first embodiment of the present invention. An apparatus for preparing a lenticular sheet 100 is structured with a transparent toner layer forming section 1, a transferring section 2, a transparent sheet supplying section 3, a lens forming section 4, and a transparent sheet exit section 5.

The transparent toner layer forming section 1 includes a photoconductor drum 11, a charging section 12, a light scanning section 13, a developing section 14, a developer replenish container 15, a drum cleaner 16, and a photoconductor discharging section 17. The photoconductor drum 11 is a roller-like member that is supported so as to be rotatably driven by a drive section (not shown) about its axis. The photoconductor drum 11 includes a photosensitive layer, and is an image carrier that carries an electrostatic latent image, and consequently, a transparent toner layer, on the surface of the photosensitive layer.

For example, the photoconductor drum 11 may be structured with a conductive substrate made of aluminum, and a photosensitive layer formed on the surface of the conductive substrate. The conductive substrate may be a conductive substrate such as of a sleeve-like cylindrical, a circular cylindrical, or a sheet-like shape. Of these, a sleeve-like cylindrical conductive substrate may preferably be used. Examples of the photosensitive layer include an organic photosensitive layer, an inorganic photosensitive layer and the like.

Examples of the organic photosensitive layer include a layered structure composed of a charge generating layer of a resin layer containing a charge generating substance and a charge transport layer of a resin layer containing a charge transporting substance, a resin layer of a single resin layer containing a charge generating substance and a charge transporting substance, or the like. An example of the inorganic photosensitive layer is a resin layer containing one or at least two selected out of zinc oxide, selenium, amorphous silicon and the like.

An undercoat layer may be interposed between the conductive substrate and the photosensitive layer. Further, on the surface of the photosensitive layer, an overcoating layer (protective layer) for protecting the photosensitive layer may be provided.

The charging section 12 is a member that charges the surface of the photoconductor drum 11 into a prescribed polarity and potential. The charging section 12 is disposed at a position facing the photoconductor drum 11 and along a longitudinal direction of the photoconductor drum 11. In a case where a contact electrifying charging device is employed, the charging section 12 is disposed so as to contact the surface of the photoconductor drum 11. In a case where a non-contact electrifying charging device is employed, the charging section 12 is disposed so as to be away from the surface of the photoconductor drum 11.

As the charging section 12, a brush type charging device, a roller type charging device, a corona discharging device, an ion generating device or the like may be employed. The brush type charging device and the roller type charging device are each the contact electrifying charging device. Some brush type charging devices employ a charging brush, and others employ a magnetic brush. The corona discharge device and the ion generating device are each a non-contact electrifying charging device. Some corona discharge devices employ a wire-like discharge electrode, and others employ a sawtooth discharge electrode, a needle-like discharge electrode, and the like.

The light scanning section 13 emits laser light that corresponds to image information made of a digital signal to the surface of the photoconductor drum 11 in a charged state to form an electrostatic latent image corresponding to the image information on the surface of the photoconductor drum 11. As the light scanning section 13, a semiconductor laser device or the like may be employed.

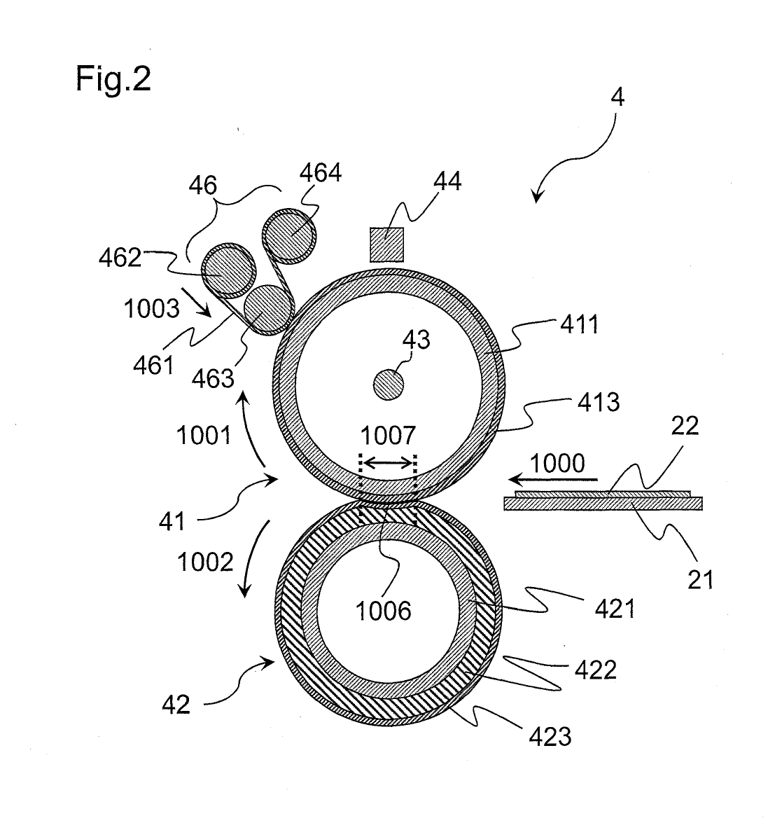

The light scanning section 13 is for setting a region where a transparent toner layer 22 (FIG. 2) is to be formed in accordance with the size of a transparent sheet 21 (FIG. 2). The light scanning section 13 is used to form an electrostatic latent image corresponding to the size of the transparent sheet 21 on the surface of the photoconductor drum 11 in order to avoid consumption of a wasteful amount of transparent toner more than needed when the transparent toner layer is formed on the surface of the photoconductor drum 11.

The developing section 14 includes a developing roller and an agitating roller. The developing roller is a roller-like member that is rotatably supported about its axis. The developing roller is provided such that a portion thereof outwardly projects from an opening formed at a plane facing the photoconductor drum 11, so as to be positioned nearby the surface of the photoconductor drum 11.

The developing roller includes therein a fixed magnetic pole (not shown), and bears a developer on the surface of the developing roller by the fixed magnetic pole. The developing roller supplies, at a nearby portion (developing nip portion) between the developing roller and the photoconductor drum 11, the borne developer to the electrostatic latent image on the surface of the photoconductor drum 11 to form a transparent toner layer on the surface of the photoconductor drum 11. The developing roller is driven to rotate in the direction opposite to that in which the photoconductor drum 11 rotates. Accordingly, at the developing nip portion, the surface of the developing roller and the surface of the photoconductor drum 11 rotate in the same direction.

The developing roller is connected to a power supply (not shown), and a DC voltage (developing voltage) is applied from the power supply. Thus, the developer on the developing roller surface is smoothly supplied to the electrostatic latent image.

The developing section 14 is a container-like member, in which an opening is formed on the plane facing the photoconductor drum 11 and an internal space is provided therein. The developing section 14 includes an agitating roller and stores the developer in the internal space. As the developer, what is commonly used in the field of image forming apparatuses can be used. The developer may be a single component developer made solely of the transparent toner, or it may be a two component developer made of the transparent toner and a carrier.

The agitating roller is a screw-like member that is rotatably supported about its axis in the internal space of the developing section 14. The agitating roller rotates to supply the developer in the developing section 14 to the surrounding of the surface of the developing roller.

The developer replenish container 15 is a container-like member, in which the developer is stored in an internal space thereof. The developer replenish container 15 replenishes the developer to the developing section 14 in accordance with the consumption state of the developer in the developing section 14.

The drum cleaner 16 removes and collects the developer remained on the surface of the photoconductor drum 11, after the transparent toner layer on the surface of the photoconductor drum 11 is transferred to the transparent sheet.

The photoconductor discharging section 17 discharges the photoconductor drum 11 after the developer is collected by the drum cleaner 16. As the photoconductor discharging section 17, an illuminating section such as a lamp can be used.

The transferring section 2 is a roller-like member that is arranged so as to be rotatably driven by a drive section (not shown) about its axis. The transferring section 2 is pressed against the photoconductor drum 11. The press-contact portion between the transferring section 2 and the photoconductor drum 11 is referred to as a transferring nip portion. To the transparent sheet supplied by the transparent sheet supplying section 3 whose description will be given later, the transparent toner layer is transferred at the transferring nip portion. The transferring section 2 transfers the transparent sheet 21 that bears the unfixed transparent toner layer 22 to the lens forming section 4.

As the transferring section 2, a roller-like member that includes a shaft made of, e.g., metal, and an electrically conductive layer that covers the surface of the metal-made shaft is used. The metal-made shaft is formed with, e.g., a metal alloy of stainless steel or the like. The electrically conductive layer is formed with an electrically conductive elastic body or the like. As the electrically conductive elastic body, what is commonly used in the field of image forming apparatuses can be used. Examples thereof include ethylene propylene diene rubber (EPDM), foamed EPDM, foamed urethane and the like, which include an electrically conductive agent such as carbon black.

The transferring section 2 is connected to a high voltage power supply (not shown). The high voltage power supplies the transferring section 2 with a high voltage of an opposite polarity relative to the charge polarity of the transparent toner layer formed on the surface of the photoconductor drum 11. Thus, the transparent toner layer formed on the surface of the photoconductor drum 11 is smoothly transferred to the surface of the transparent sheet.

The transparent sheet supplying section 3 includes transparent sheet cassettes 31 and 31b, a pickup roller 32, conveyance rollers 34, and registration rollers 35. The transparent sheet cassettes 31 and 31b store therein the transparent sheets 21. The size of the transparent sheets 21 may be, e.g., A4, A3, B5, B4, a postcard size and the like.

The pickup roller 32 is a roller-like member that feeds the transparent sheets to the conveyance rollers 34 one by one. The transparent sheets stored in the transparent sheet cassette 31 are each conveyed to the conveyance rollers 34 by the pickup roller 32. The transparent sheets 21 stored in the transparent sheet cassette 31b are each fed to the conveyance rollers 34 through a transparent sheet inlet 33a.

The conveyance rollers 34 are paired roller-like members disposed so as to be pressed against each other. The conveyance rollers 34 feed the transparent sheet to the registration rollers 35.

The registration rollers 35 are paired roller-like members disposed so as to be pressed against each other. The registration rollers 35 feed the transparent sheet to the transferring nip portion in synchronization with the transparent toner layer on the photoconductor drum 11 being conveyed to the transferring nip portion.

The transparent sheet exit section 5 is provided downstream to the lens forming section 4, at which each lenticular sheet having a lens formed thereon exits.

### <<Structure of Lens Forming Section>>

Next, a description will be given of the structure of the lens forming section 4 in the apparatus for preparing a lenticular sheet 100.

FIG. 2 is a cross-sectional view showing the structure of the lens forming section according to the first embodiment of the present invention.

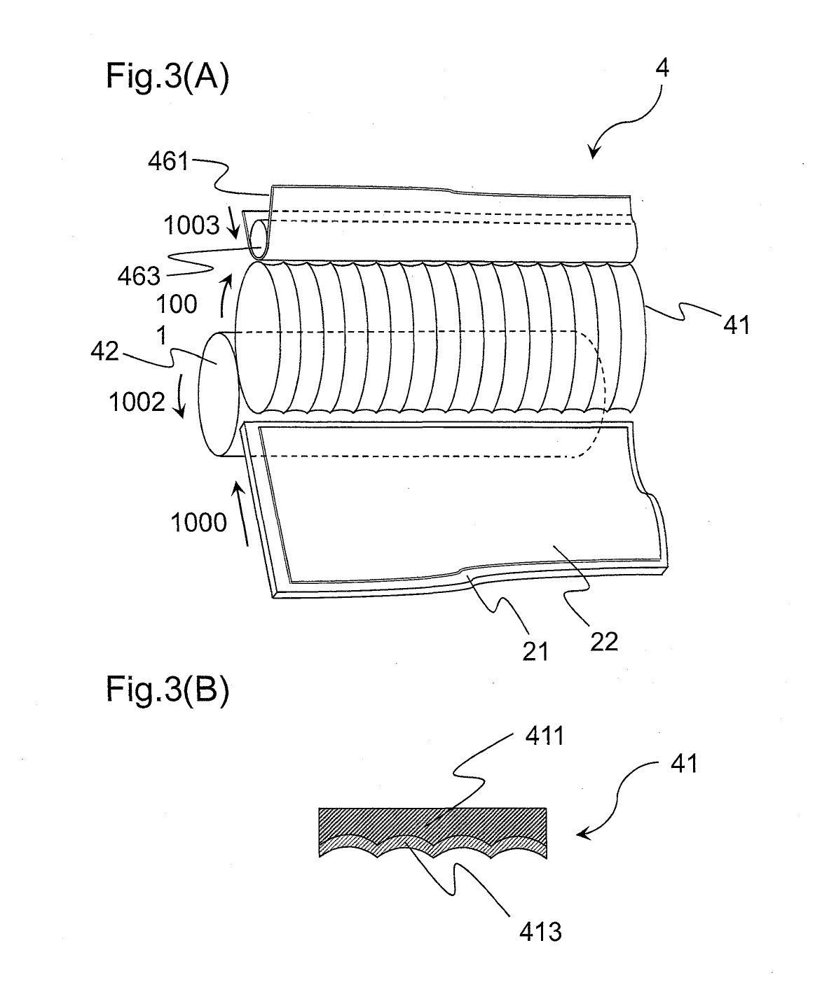

FIG. 3(A) is a perspective view of a chief part of the lens forming section shown in FIG. 2 of the present invention.

FIG. 3(B) is a partial cross-sectional view of the outer circumferential surface of the lens forming roller shown in FIG. 3(A).

The lens forming section 4 is composed of paired lens forming rollers (a lens forming roller 41 and a pressure roller 42). Through a lens forming nip portion 1006 formed by the paired lens forming rollers 41 and 42, the transparent sheet 21 bearing the transparent toner layer 22 passes (F is the feed direction of the transparent sheet). At the lens forming nip portion 1006, the transparent toner layer 22 formed as a layer on the transparent sheet 21 undergoes hot forming by the heat from a heat source (a halogen lamp 43) inside the lens forming roller 41 and the pressure of the outer circumferential surface of the lens forming roller 41, to be formed as a lenticular lens. Of the paired rollers, the lens forming roller 41 positioned on the transparent toner surface side has its both ends in the axial direction supported, so as to be rotatable by a drive source (not shown). The lens forming roller 41 includes a core metal 411 and a release layer 413. As the material structuring the core metal 411, for example, aluminum, iron, stainless steel or the like may be used. The shape of the core metal 411 is right circular sleeve-like cylindrical. Both the ends in the axial direction of the core metal 411 each may have or may not have a drawing structure.

Further, on the surface of the lens forming roller 41, the release layer 413 is formed for securing the releasability of the transparent toner. Examples of the material of the release layer 413 are a fluoric resin material such as PFA (tetrafluoroethylene-perfluoro alkyl vinyl ether copolymer), PTFE (polytetrafluoroethylene) and the like. Alternatively, a DLC (diamond-like carbon) material containing such fluoroplastic or the like may be used. It is to be noted that the thickness is preferably about 50 nm to 30 μm. When it is extremely thin, its durability becomes a concern; when it is extremely thick, as a result of a great change in the groove shape, e.g., the groove section being buried, the lens formation may not be carried out successfully.

It is to be noted that, in order to secure the releasability of the transparent toner, a mold release agent such as silicone oil may be applied instead of forming the release layer 413 on the surface of the lens forming roller 41. As the silicone oil, an oil whose viscosity is from about 1,000 CS to 10,000 CS can be used.

As shown in FIG. 3(A), on the surface of the lens forming roller 41, multitude of grooves each having a concave surface shape are formed such that the transparent toner on the transparent sheet can be formed into lens shapes. The formation direction of the grooves is formed along a rotation direction 1001 of the lens forming roller 41.

As shown in FIG. 3(B), on the surface of the lens forming roller 41, a plurality of grooves are formed at a prescribed pitch. Examples of a groove work method are a machine work using a metal-made cutting tool or the like, or a work through the use of laser.

On the other hand, as the pressure roller 42 on the side being in contact with the surface opposite to the transparent toner layer, normally, a so-called pressure roller which is used at the fusing section of an electrophotographic type image forming apparatus can be used.

The pressure roller 42 has its both ends in the axial direction supported, and is provided so as to be rotatable in a state where it is pressed by a pressurizing mechanism (not shown) against the lens forming roller 41. The pressure roller 42 includes a core metal 421, an elastic layer 422, and a release layer 423.

Examples of the material structuring the core metal 421 are aluminum, iron, stainless steel and the like. The shape of the core metal 421 is right circular sleeve-like cylindrical. Both ends in the axial direction of the core metal 421 each may have or may not have a drawing structure.

The elastic layer 422 is provided to increase the region of the lens forming nip portion 1006 formed with the lens forming roller 41 and the pressure roller 42, and is provided on the outer circumferential surface of the core metal 421. As the material for structuring the elastic layer 422, a material having a rubberlike elasticity, more preferably, a material having a rubberlike elasticity and possessing an excellent heat resistance may be used. Specific examples are silicone rubber, fluoro rubber, fluorosilicone rubber and the like. Further, it may be a foamed product of such materials. In particular, the silicone rubber exhibiting an excellent rubberlike elasticity is preferable. A lens forming nip width 1007 (the length in the feed direction of the transparent sheet 21 at the lens forming nip portion 1006) is preferably 7 mm, for example.

The release layer 423 is provided on the outer circumferential surface of the elastic layer 422. As the material structuring the release layer 423 of the pressure roller 42, a material possessing excellent heat resistance and durability, and being less adhesive to the toner may be used. Specific examples of the material structuring the release layer 423 include a fluoric resin material such as PFA (tetrafluoroethylene-perfluoro alkyl vinyl ether copolymer), PTFE (polytetrafluoroethylene), fluoro rubber and the like. In a case where PFA or PTFE is employed, a tube made of such a material may be covered or coated. It is to be noted that the thickness of the release layer 423 is preferably 10 μm to 50 μm.

To each of the both ends in the axial direction of the core metal of the pressure roller 42, a ball bearing is inserted so as to be driven by the rotation of the lens forming roller 41 (1001 and 1002 indicate the rotation directions of the lens forming roller and the pressure roller, respectively).

The pressure roller 42 presses the lens forming roller 41 by a pressurizing mechanism (not shown) with a pressing force which is uniform in its axial direction and whose total load is 400 N.

A thermostat 44 is a temperature adjusting member that adjusts the temperature of the lens forming roller 41. By the thermostat 44, an optimum temperature for forming the transparent toner layer is maintained.

Next, a description will be given of a cleaning section 46 for the transparent toner.

The cleaning section 46 includes a web 461, a web feed roller 462, a web press roller 463, and a web wind roller 464, and removes an offset toner or the like adhered to the surface.

The web 461 is fed from the web feed roller 462 toward the web press roller 463, and wound around the web press roller 463 to be pressed against the roller surface. Thereafter, the web 461 is wound up by the web wind roller 464. The press portion between the web 461 and the roller surface on each other serves as a cleaning nip portion.

In the first embodiment, the web 461 having a thickness of 40 μm is used. Further, the web 461 can be impregnated with an oil having a releasing effect or the like. As the oil, what is commonly used in the field of image forming apparatuses can be used. An example thereof is a silicone oil, such as dimethyl silicone oil, amino modified silicone oil, mercapto modified silicone oil, fluoro modified silicone oil and the like. In the first embodiment, a silicone oil having a viscosity of about 0.01 m²/s (10000 centistokes, 25° C.) is impregnated.

The web feed roller 462 is supported so as to be rotatably driven about its axis, and the web 461 is wound around the surface of the web feed roller 462 to be retained thereby. In the first embodiment, the web feed roller 462 is driven to rotate in the direction of a web feed direction 1003 to feed the web 461.

The web press roller 463 is a roller-like member whose both ends in the longitudinal direction are pivotally supported by bearings (not shown) so as to be rotatably driven. The web press roller 463 is provided to be pressed against the roller surface by a pressing section (not shown) through the web 461. The web press roller 463 is driven to rotate when the web wind roller 464 operates to wind up the web 461. As the web press roller 463, a roller-like member that includes a core metal made of metal and an elastic layer formed on the surface of the core metal made of metal may be used. Examples of the elastic material structuring the elastic layer are a heat resistance rubber such as a silicone rubber, and a foamed product thereof. Though the surface hardness of the elastic layer is not particularly limited, it is preferably 20° to 30° (Asker-c, Asker C hardness).

As the pressing section, a spring member or the like is used, for example. The width in the longitudinal direction of the web press roller 463 should be set to be greater than the maximum width of the lenticular sheet preparing region that is to be formed in the apparatus for preparing a lenticular sheet 100. Further, since the width of the cleaning nip portion (a cleaning nip width) has a great effect on the cleaning performance of the cleaning section 46, it is preferable that an appropriate range is designed. The cleaning nip width is chiefly determined by the pressing force of the web press roller 463 to the roller, and the roller diameter of the web press roller 463 and the like.

The web wind roller 464 is supported so as to be rotatably driven by a drive section (not shown) about its axis, to wind up the web 461 having brought into contact with the roller. By the rotation of the web wind roller 464, the web 461 is fed from the web feed roller 462, to start a cleaning operation. The operation of the cleaning section 46 is controlled by a CPU (not shown). The CPU senses that a prescribed pieces of transparent sheets have passed through the lens forming nip portion 1006 based on the sensor, the number of rotation of the roller and the like, and thereafter sends a control signal to a drive section (not shown) (in the present embodiment, a motor provided inside the body of the apparatus for preparing a lenticular sheet 100) that rotates the web wind roller 464. The drive section that received the control signal rotates the web wind roller 464 to wind up the web 461 by a certain amount. This winding up feeds the web 461 from the web feed roller 462 in the web feed direction 1003. In this manner, the offset toner and the like on the roller surface are collected and cleaned.

It is to be noted that, in the first embodiment, while the exemplary operation in which the web wind roller 464 intermittently winds up is shown, the present invention is not limited thereto. The winding up may continuously be carried out in synchronization with the timing at which the transparent sheet passes through the lens forming nip portion 1006.

Next, a description will be given of the transparent toner.

Examples are polystyrene resin, a resin composed of homopolymer of styrene-substitution product, a styrene based copolymer resin, a polyvinyl chloride resin, a polyvinyl acetate resin, a polyethylene resin, a polypropylene resin, a polyester resin, a polyurethane resin and the like. Such binder resins may be used solely, or may be used in combination of at least two.

Of those binder resins, as the binder resin for the transparent toner, a binder resin whose softening point is 100 to 150° C. and glass transition point is 50 to 80° C. is preferable, taken into consideration of preserving performance, durability and the like, and a polyester resin whose softening point and glass transition point fall within the foregoing ranges is preferable. From the viewpoint of transparency, a COC resin is also excellent.

The transparent toner contains a mold release agent. The mold release agent is not particularly limited, and wax can be used, for example. As the wax, what is commonly used in the field of image forming apparatuses can be used. Examples are polyethylene wax, polypropylene wax, paraffin wax, ester wax and the like.

The content of the mold release agent is not particularly limited, so long as it falls within a commonly used range.

The transparent toner may contain, in addition to the binder resin and the mold release agent, a general additive or external additive for the transparent toner such as a charge control agent.

The charge control agent is not particularly limited, so long as it can charge the transparent toner or it can control such charging. However, it is preferable that the charge control agent does not affect the transparency of the transparent toner. General examples of such a charge control agent are nigrosine dye, quaternary ammonium salt, triphenylmethane derivatives, salicylic acid complexes, naphthol acid zinc complexes, a metal oxide of benzilic acid derivatives and the like. Such charge control agents may be used solely, or may be used in combination of at least two.

The content of the charge control agent is not particularly limited, so long as it falls within a commonly used range.

The transparent toner is manufactured in accordance with any known method for toner mother particles. Examples include grinding, suspension polymerization, emulsion polymerization and coagulation and the like.

Though the volume average particle diameter of the transparent toner is not particularly limited, 2 μm to 10 μm is preferable. This is for forming a transparent toner layer of a uniform thickness as much as possible including the edge of the region, in forming the lenticular lens.

In a case where the volume average particle diameter is smaller than 2 μm, the fluidity of the obtained transparent toner becomes poor. Thus, in a developing operation, supply, agitation and charging of the transparent toner become insufficient. Such a situation invites lack in the amount of the transparent toner, an increase in the oppositely-charged toner and the like. As a result, a problem such as incapability of forming an excellent transparent toner layer may arise. On the other hand, in a case where the volume average particle diameter of the toner is greater than 10 μm, a problem such as impaired uniformity in the thickness of the transparent toner layer may arise.

The external additive is added for the purpose of improving the powder flowability, triboelectric chargeability, heat resistance, long-term preserving performance, and cleaning performance of the transparent toner, and of providing the function of wear characteristic control of the photoconductor surface and the like. Specifically, any external additive that is commonly used in the field of image forming apparatuses, e.g., silica, alumina, fine titanium oxide or acrylic powder, fine metallic soap particles or the like is used. The added amount is not particularly limited, so long as it falls within a commonly used range.

It is to be noted that the transparent toner layer 22 manufactured in this manner can be used as a single component developer as it is; alternatively, it may be used as a two component developer by being mixed and agitated with the carrier particles.

The two component carrier particles used as the developer is not particularly limited, and the carrier particles commonly used in the field of image forming apparatuses can be used. For example, it is preferable to use carrier particles formed with: a magnetic material of iron, nickel, cobalt or the like; or a magnetic oxide of ferrite, magnetite or the like. Further, what can also be used are such carrier particles being employed as the core particles having their surfaces coated with a resin material. All of these carrier particles should preferably be selected as appropriate in accordance with the toner component, and may be used solely, or may be used in combination of at least two. Though the particle diameter of each of the carrier particles is not particularly limited, the particle diameter is preferably equal to or greater than 30 μm and equal to or smaller than 100 μm for obtaining a uniform image.

Further, the manufacturing method of the two component developer is not particularly limited, and it can be manufactured according to any conventionally known method. It is preferable that the transparent toner layer 22 of the present invention is contained by equal to or greater than 3% by weight and equal to or smaller than 20% by weight relative to the total amount of the two component developer.

### Example

In the following, an Example is specifically described in detail.

### (Transparent Toner)

Resin: polyester resin (94.5 parts)

Charge control agent: a metal oxide of a benzilic acid derivative (0.5 parts)

Wax: polyethylene wax (5.0 parts)

The following was used as the external additive:
1.0 part of small particle diameter silica relative to the transparent toner; and
1.5 parts of titanium oxide relative to the transparent toner.

The developer of a two component developer was prepared, in which the transparent toner ratio to the developer was 8%.

### (Lens Forming Roller)

The lens forming roller was formed by mechanically working the surface of an aluminum-made roller having an outer diameter of 40 mm, a thickness of 2 mm, and a barrel length of 315 mm, such that grooves are formed each at a pitch of about 181 μm in the roller rotation direction in a depth of about 30 μm and a width of about 300 mm.

In order to secure the releasability of the transparent toner, the surface was coated with fluorine. The thickness of the fluorine coat was set to be about 10 μm.

### (Pressure Roller)

On the outer circumferential surface of an iron-made core metal having no drawing structure and having an outer diameter of 29.76 mm, an inner diameter of 23.76 mm, and a thickness of 3 mm, a silicone rubber layer having a thickness of 5 mm was provided as the elastic body. The silicone rubber was a product of a JIS-A hardness of 30°. The release layer was a PFA tube layer having a thickness of 50 μm. The product was a roller whose outer diameter was 40.0 mm. Further, the axial direction length of the core metal was 313 mm, and the axial direction length of the elastic body layer was 312 mm. The load was 400 N.

### (Lamp)

Inside the lens forming roller, a halogen lamp for heating the roller from inside was provided.

### (Transparent Sheet)

A PET sheet of A4 size and of a thickness of about 300 μm was used.

A transparent toner layer having a thickness of about 25 μm was formed on a transparent sheet. Thereafter, fixing was performed with the lens forming roller having a temperature of about 150° C. and at a rate of 50 mm/sec. In this manner, the lens formation on the transparent sheet was performed.

As a result, a lens section was formed over the entire A4 sheet with the pitch of about 181 μm and at a height of about 30 μm.

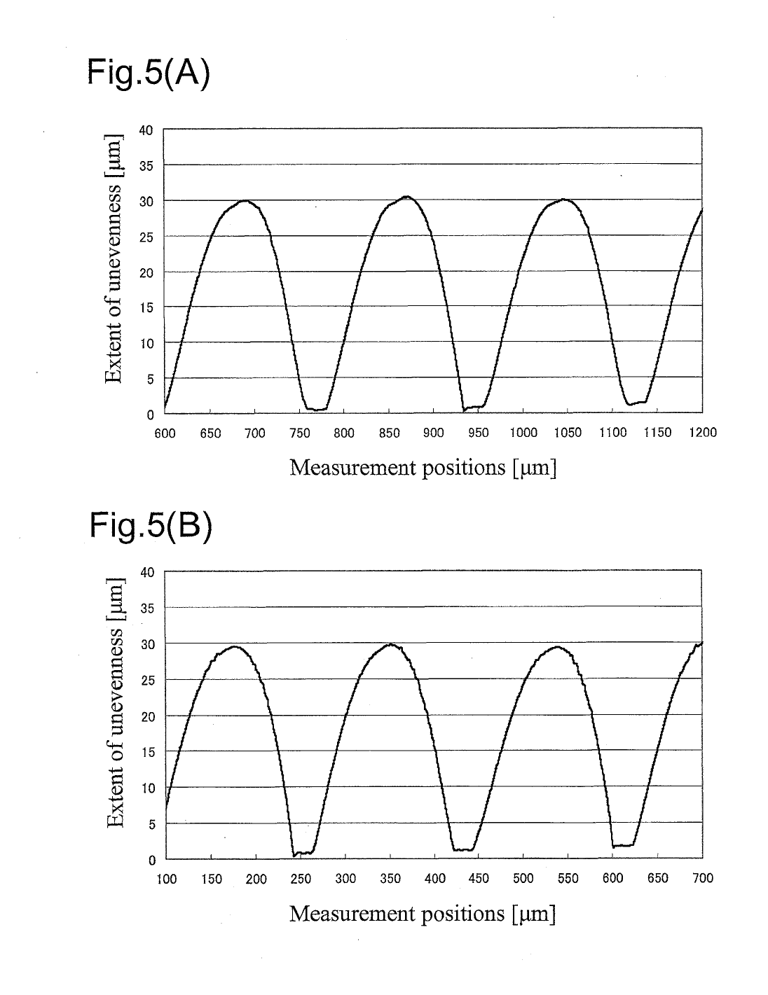

FIG. 5(A) shows a result of measuring the lenticular sheet surface on which the lens was formed by the apparatus for preparing a lenticular sheet according to the first embodiment of the present invention with a surface roughness meter. The horizontal axis indicates measurement positions (unit: μm) in the direction of the lens forming roller shaft of the lenticular sheet surface; and the vertical axis indicates the extent (unit: μm) of unevenness of the lenticular sheet surface. As shown in FIG. 5(A), in a case where the groove direction of the lens forming roller was aligned in the feed direction of the transparent sheet, an excellent lenticular lens shape was obtained.

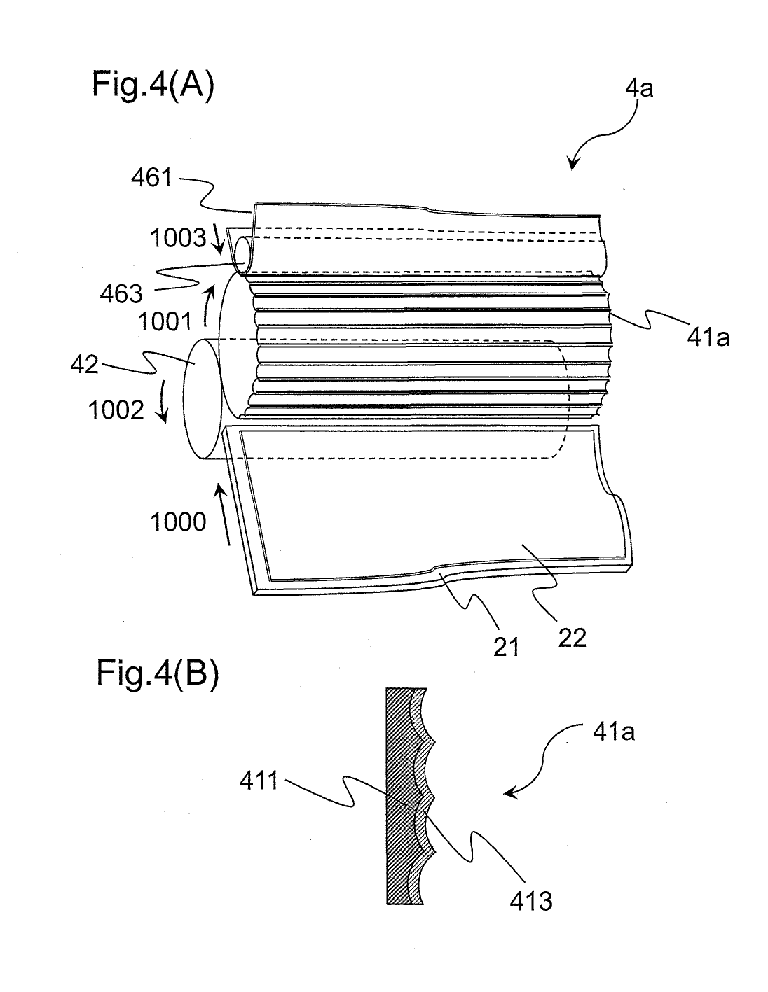

With reference to FIG. 4, a description will be given of the lens forming section 4a according to a second embodiment of the present invention.

It is to be noted that, the second embodiment has a structure identical to that of the first embodiment except for the groove formation direction of the lens forming roller. Therefore, as to the structure similar to that of the first embodiment, a description will be given using the identical reference symbol. The same holds true for the third embodiment.

FIG. 4(A) is an explanatory diagram showing the lens forming roller according to the second embodiment.

FIG. 4(B) is a partial cross-sectional view of an outer circumferential surface of the lens forming roller shown in FIG. 4(A).

As shown in FIG. 4(A), a lens forming roller 41a according to the present embodiment is formed such that the groove direction extends perpendicularly to the feed direction of the transparent sheet, i.e., the axial direction of the lens forming roller.

As shown in FIG. 4(B), on the surface of the lens forming roller 41a, a plurality of grooves are formed at a prescribed pitch. Examples of groove work method are a machine work through the use of a metal-made cutting tool or the like, and a work through the use of laser.

It is to be noted that, in the second embodiment, in a case where the grooves are formed in the axial direction of the lens forming roller 41a, in order to consistently keep the interval between adjacent ones of the grooves on the surface of the lens forming roller 41a constant along the entire circumference of the roller, the outer circumferential length of the lens forming roller 41a must be set to be just an integer multiple of each pitch width of the lenticular lens. When it is not set to be an integer multiple, the interval of the grooves becomes shorter (or longer) at one portion of the roller surface than the other portions to invite a mismatch, which causes the lens pitch width to be nonuniform.

It is to be noted that, by setting the diameter of the lens forming roller 41a such that the circumferential length of the roller becomes longer than the length of the transparent sheet 21 in the feed direction 1000, even when a mismatch of the interval of the grooves occurs at a portion of the surface of the lens forming roller 41a, the lens is formed by using solely the region where the interval of the grooves is uniform, so that it becomes possible to prevent the lens pitch width from becoming nonuniform. Specifically, by detecting the position of the rotation direction 1001 of the lens forming roller 41a and starting to convey the transparent sheet 21 at a position on the surface of the lens forming roller 41a where the region in which the interval of the grooves becomes constant commences, the lens is formed. It is to be noted that, the position of the rotation direction 1001 of the lens forming roller 41a may be detected by, for example, providing a mark on the lens forming roller 41a, to be sensed by an optical sensor or the like.

FIG. 5(B) shows the lens formation result by an apparatus for preparing a lenticular sheet according to the second embodiment of the present invention. It is to be noted that, the present Example is identical to the Example shown in FIG. 5(A) except that the grooves on the lens forming roller surface are formed in the axial direction of the lens forming roller.

FIG. 5(B) shows a result of measuring the lenticular sheet surface on which the lens was formed by the apparatus for preparing a lenticular sheet according to the second embodiment of the present invention with a surface roughness meter. The horizontal axis indicates measurement positions (unit: μm) in the direction of the lens forming roller shaft of the lenticular sheet surface; and the vertical axis indicates the extent (unit: μm) of unevenness of the lenticular sheet surface.

As shown in FIG. 5(B), a lenticular lens with the pitch of about 181 μm and at a height of about 30 μm was prepared. It is to be noted that, depending on the conditions such as the heating temperature of the lens forming roller 41a, the thickness of the transparent toner layer 22, the lens forming nip width 1007, the pressure of the lens forming nip portion 1006 and the like, as a result of the transparent toner being pushed to flow along the circumferential direction of the lens forming roller, in some cases, the lens shape deforms along the circumferential direction of the lens forming roller. However, a lenticular sheet with the substantially uniform lens pitch width and the smooth lens shape was obtained.

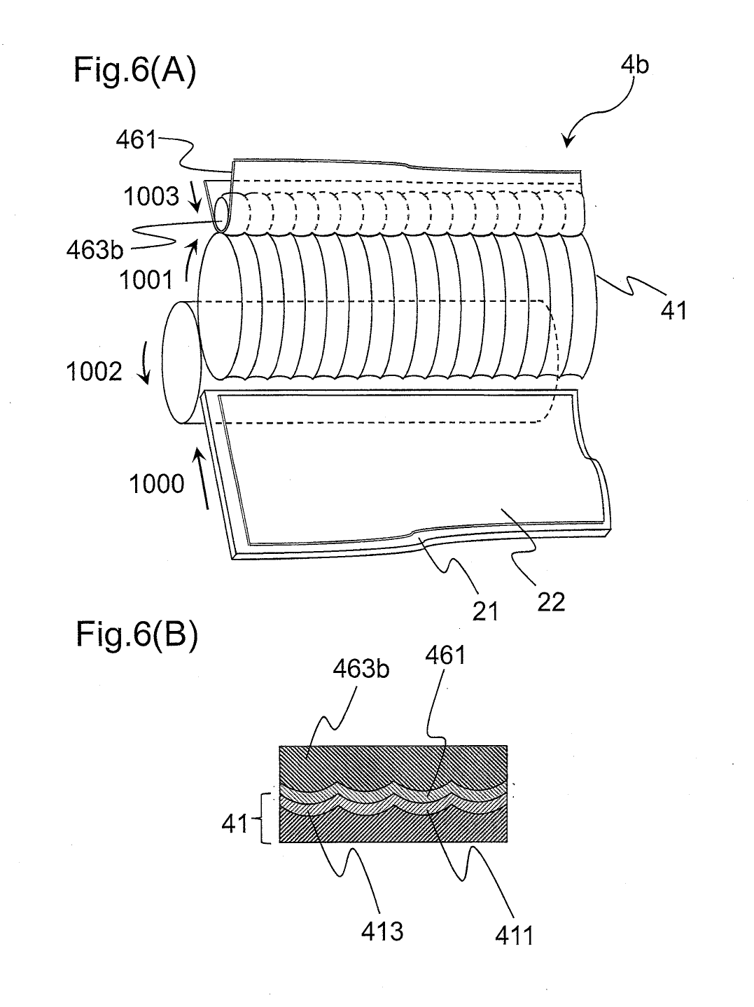

Next, with reference to FIG. 6, a description will be given of a variation of the web press roller according to the first embodiment of the present invention.

It is to be noted that, the present variation has a structure identical to that of the first embodiment except for the shape of the web press roller.

FIG. 6(A) is an explanatory diagram showing a variation of the web press roller according to the first embodiment of the present invention.

FIG. 6(B) is a partial cross-sectional view of the lens forming roller and the web press roller shown in FIG. 6(A) nearby the cleaning nip portion.

As shown in FIG. 6(A), a web press roller 463b of the cleaning section 46 has convex planes corresponding to the concave plane-like grooves of the lens forming roller 41.

As shown in FIG. 6(B), nearby the cleaning nip portion, the web press roller 463b can closely be brought into contact with the bottom of the groove section of the lens forming roller 41. Therefore, the offset toner adhered to the bottom plane of each concave plane-like groove of the lens forming roller 41 can also be removed.

As compared to a normal fixing-purpose roller having no unevenness on its surface, the lens forming roller 41 has a multitude of the concave plane-like grooves on its surface and, therefore, in a case where the releasability of the transparent toner cannot fully be secured, the offset toner may adhere to the bottom plane of the concave plane-like grooves. Normally, in a case where the lens forming roller 41 has a smooth shape, by deformation of the elastic layer formed on the surface of the web press roller 463, the cleaning nip portion is formed. However, as each pitch becomes narrower and each groove becomes deeper, removal of the offset toner adhered to the bottom plane of the grooves becomes difficult because the deformation of the elastic layer is limited. On the other hand, by providing a work to the shape of the web press roller 463b so as to conform to the shape of the lens forming roller 41, removal of the offset toner adhered to the bottom plane of the grooves becomes possible. Accordingly, even in a case where a plurality of grooves are formed on the lens forming roller surface, an apparatus for preparing a lenticular sheet that withstands use of a long term with high durability can be implemented.

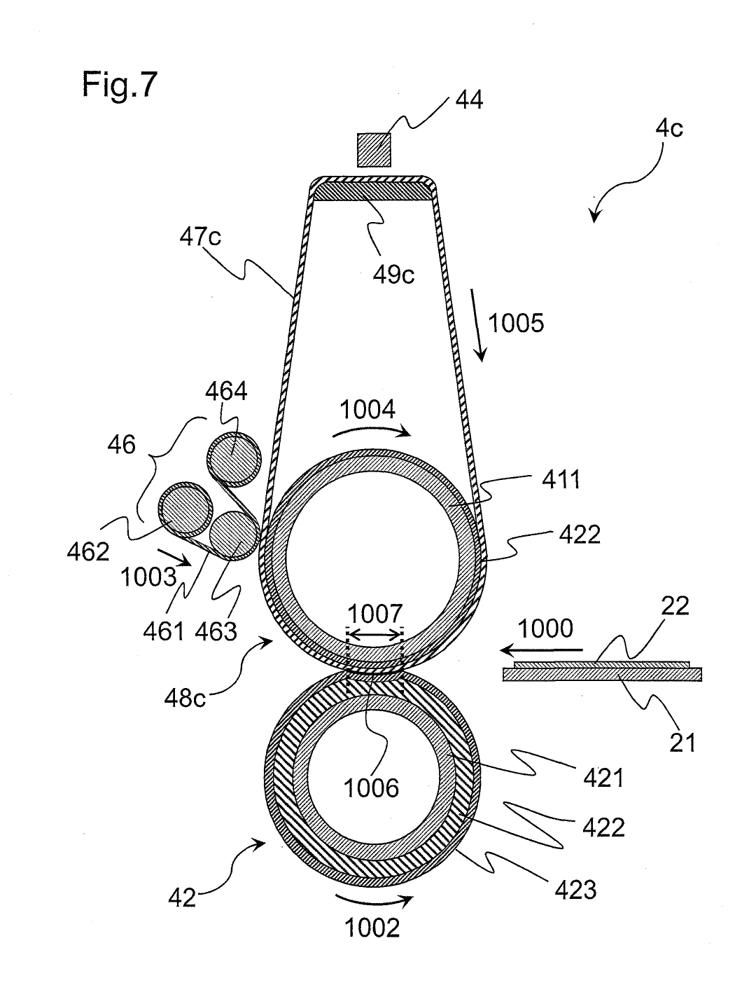

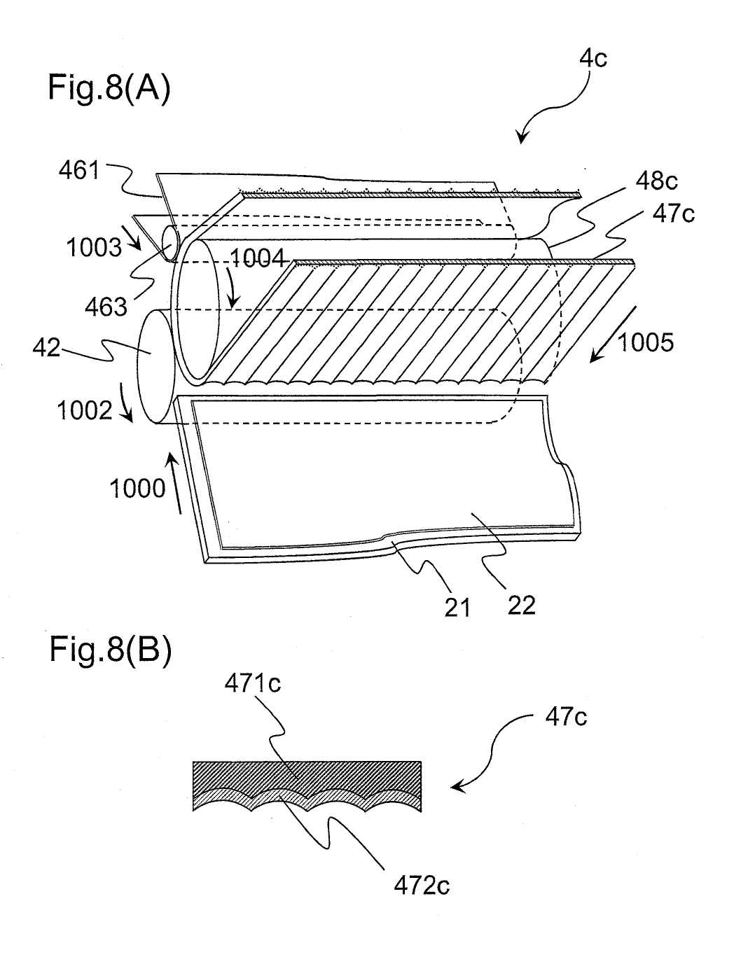

Next, with reference to FIGS. 7 and 8, a description will be given of an apparatus for preparing a lenticular sheet to a third embodiment of the present invention.

It is to be noted that, the third embodiment has a structure basically identical to the first embodiment except that the lens forming section is roller-shaped or belt-shaped.

FIG. 7 is a cross-sectional view showing the structure of the lens forming section according to the third embodiment of the present invention.

FIG. 8(A) is a perspective view of a chief part of the lens forming section shown in FIG. 7.

FIG. 8(B) is a partial cross-sectional view of an outer circumferential surface of the lens forming belt shown in FIG. 8(A).

As shown in FIG. 7, the lens forming section 4c according to the third embodiment includes a belt support roller 48c, an lens forming belt 47c, a belt support member 49c on which the lens forming belt 47c is suspended and which has a heater for heating the lens forming belt 47c, a pressure roller 42, a thermostat 44 being a temperature adjusting member for adjusting the temperature of the lens forming belt 47c, and a pressure spring (not shown) for applying pressure such that the belt support roller 48c and the pressure roller 42 are pressed against each other, a pressure releasing mechanism (not shown) for releasing the press-contact, and a cleaning section 46 for removing the transparent toner adhered to the lens forming belt 47c.

The belt support roller 48c and the pressure roller 42 are pressed against each other by the pressure spring by a prescribed load (e.g., 400 N), whereby a lens forming nip portion 1006 (a portion where the belt support roller 48c and the pressure roller 42 abut on each other) is formed between the rollers.

The belt support member 49c having a heater is for supporting the lens forming belt 47c, and for being brought into contact with the lens forming belt 47c to quickly heat the lens forming belt 47c to a prescribed temperature.

The belt support roller 48c according to the third embodiment is intended to be brought into contact with the pressure roller 42 through the lens forming belt 47c to form the lens forming nip portion 1006, and at the same time, to drive the lens forming belt 47c by its rotation.

As the belt support roller 48c, a two-layered structure roller in which a core metal 411 and an elastic layer 422 in order from the inside can be used, for example. As the core metal 411, metal such as iron, stainless steel, aluminum, copper or an alloy thereof can be used, for example. Further, as the elastic layer 422, a rubber material having a heat resistance, such as silicone rubber, fluoro rubber and the like is suitable.

As the belt support roller 48c, for example, what is used is a roller including an iron-made core metal having an outer diameter of 30 mm, an inner diameter of 24 mm, and a thickness of 3 mm, on the outer circumferential surface of which a silicone rubber layer of a thickness of 5 mm is provided. Instead of the silicone rubber layer, a silicone sponge layer can be provided.

It is to be noted that the other constituents are basically identical to the first embodiment.

### <<Structure of Lens Forming Belt>>

Next, a description will be given of the structure of the lens forming belt 47c according to the third embodiment.

As shown in FIG. 7, the lens forming belt 47c is an endless belt which is suspended by the belt support member 49c having a heater and the belt support roller 48c. The lens forming belt 47c moves in its feed direction 1005, following a rotation direction 1004 of the belt support roller 48c when the belt support roller 48c rotates. The lens forming belt 47c is elastic, and it forms a hollow cylindrical shape having a diameter of, e.g., 50 mm, when it is allowed to be cylindrical without being suspended by the belt support roller 48c.

As shown in FIG. 8(B), the lens forming belt 47c is structured by two layers of a belt substrate 471c and a belt release layer 472c in order from the inner circumferential side. On the surface of the lens forming belt 47c, a plurality of grooves are formed at a prescribed pitch. Examples of groove work methods are a machine work through the use of a metal-made cutting tool or the like, and a work through the use of laser. As the belt substrate 471c of the lens forming belt 47c, a metal material such as aluminum, iron, stainless steel and the like can be used, for example. On the outer circumferential surface of the belt substrate 471c, the belt release layer 472c is formed to secure the releasability of the transparent toner. Similarly to the release layer 413 in connection with the lens forming roller 41, an example of the material of the belt release layer 472c includes a fluoric resin material such as PFA (tetrafluoroethylene-perfluoro alkyl vinyl ether copolymer), PTFE (polytetrafluoroethylene) and the like. Alternatively, a DLC (diamond-like carbon) material which contains these fluoroplastics may be used. It is to be noted that the thickness thereof is preferably about 50 nm to 30 μm. Similarly to the first embodiment, when it is excessively thin, its durability becomes a concern; when it is extremely thick, as a result of a great change in the groove shape, e.g., the groove section being buried, the lens formation may not be carried out successfully.

It is to be noted that, in order to secure the releasability of the transparent toner, a mold release agent such as silicone oil may be applied. As the silicone oil, an oil whose viscosity is from about 1,000 CS to 10,000 CS can be used.

By allowing the transparent sheet 21 having the transparent toner layer 22 formed on its surface fed in the feed direction 1000 to pass through the lens forming nip portion 1006, the transparent toner layer 22 is subjected to hot forming by the heat and pressure of the outer circumferential surface of the lens forming belt 47c, whereby a lenticular lens is formed on the transparent sheet 21. When the transparent sheet 21 bearing the transparent toner layer 22 passes through the lens forming nip portion 1006, the lens forming belt 47c abuts on the plane of the transparent sheet 21 where the transparent toner layer 22 is to be formed; and the pressure roller 42 abuts on the plane opposite to the plane of the transparent sheet 21 where the transparent toner layer 22 is to be formed. A lens forming nip width 1007 (the length in the feed direction of the transparent sheet 21 at the lens forming nip portion 1006) is preferably 7 mm, for example.

As shown in FIG. 8(A), on the plane of the lens forming belt 47c abutting on the transparent toner layer 22, a multitude of concave surface shaped grooves are formed, such that the transparent toner on the transparent sheet 21 can be formed into lens shapes. In the third embodiment, the grooves are formed in the direction parallel to the feed direction 1000 of the transparent sheet 21, that is, in the rotation direction of the belt support roller 48c.

As shown in FIG. 8(B), the lens forming belt 47c is structured by the two layers of the belt substrate 471c and the belt release layer 472c in order from the inner circumferential side. On the surface of the lens forming belt 47c, a plurality of grooves are formed at a prescribed pitch. Examples of groove work methods are a machine work through the use of a metal-made cutting tool or the like, and a work through the use of laser.

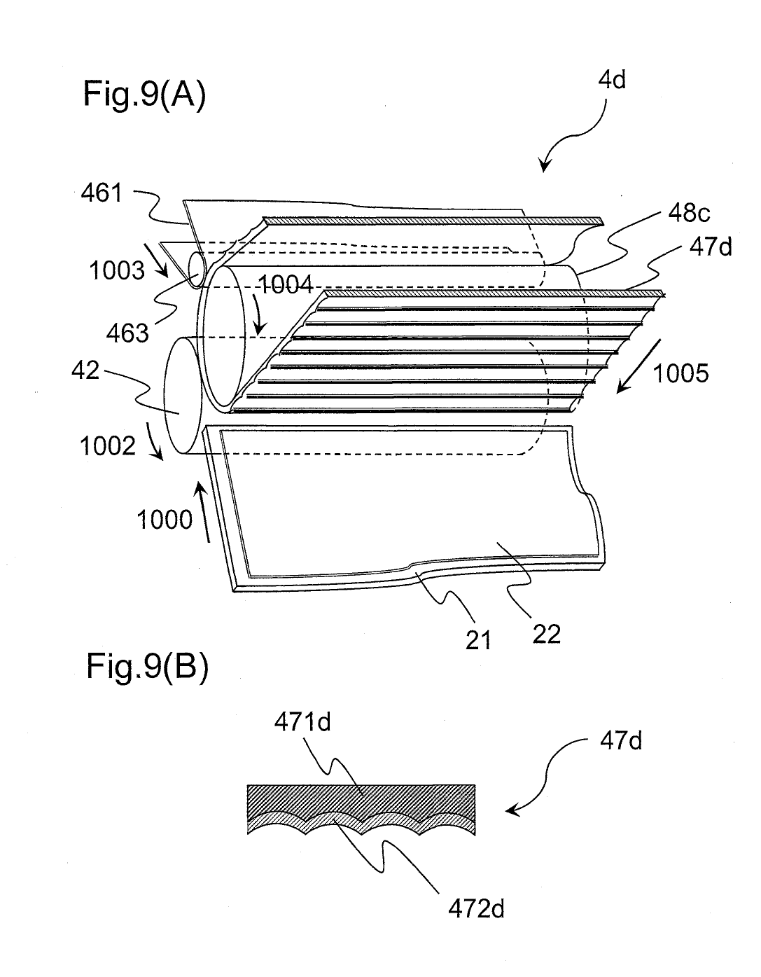

Next, with reference to FIG. 9, a description will be given of variation of a lens forming belt according to the third embodiment of the present invention.

It is to be noted that, the present variation has a structure identical to the third embodiment except for the groove formation direction of the lens forming belt.

FIG. 9(A) is an explanatory diagram showing the variation of the lens forming belt according to the third embodiment of the present invention.

FIG. 9(B) is a partial cross-sectional view of the lens forming belt shown in FIG. 9(A).

As shown in FIG. 9(A), on the plane of the lens forming belt 47d abutting on the transparent toner layer 22, a multitude of concave surface shaped grooves are formed, such that the transparent toner on the transparent sheet 21 can be formed into lens shapes. In the present variation, the grooves are formed in the direction perpendicularly to the feed direction 1000 of the transparent sheet 21, that is, in the axial direction of the belt support roller 48c.

As shown in FIG. 9(B), the lens forming belt 47d is structured by two layers of the belt substrate 471d and the belt release layer 472d in order from the inner circumferential side. On the surface of the lens forming belt 47d, a plurality of grooves are formed at a prescribed pitch. It is to be noted that the material and the structure of the lens forming belt 47d are identical to those of the lens forming belt 47c according to the third embodiment.

In the lens forming roller 41a, in a case where the grooves are formed in the axial direction of the lens forming roller 41a, in order to consistently keep the interval between adjacent ones of the grooves on the surface of the lens forming roller 41a constant along the entire circumference of the roller, the outer circumferential length of the lens forming roller 41a must be set to be just an integer multiple of the pitch width of the lenticular lens. When it is not set to be an integer multiple, the interval of the grooves become shorter (or longer) at one portion of the surface of the lens forming roller 41a than the pitch width of the lenticular lens, which causes a non-uniformity.

However, use of the lens forming belt according to the present variation allows the outer circumferential length of the lens forming belt 47d to be set freely, without being dependent on the diameter of the belt support roller 48c. Hence, adjustment is facilitated, and the uniformity in the interval of the grooves on the surface of the lens forming belt 47d can be secured with ease. Further, in the manufacturing process of the lens forming belt, even when a non-uniformity partially occurs as to the interval of the grooves on the surface of the lens forming belt 47d, in a case where the length of a portion on the surface of the lens forming belt where the interval of the grooves is uniform is longer than the length in the feed direction of the transparent sheet 21, solely the portion where uniformity is secured can be used in forming the lens, while avoiding the nonuniform portion. At this time, the position of the feed direction 1005 of the lens forming belt 47d is detected, and conveyance of the transparent sheet 21 from the portion where the interval of the grooves on the lens forming belt 47d becomes uniform is started, so that the portion of the lens forming belt 47d where the grooves are uniform is brought into contact with the transparent sheet 21. The position detection of the feed direction 1005 of the lens forming belt 47d may be performed by, for example, providing a mark on the lens forming belt 47d, to be sensed by an optical sensor or the like.

In this manner, even when the diameter of the belt support roller 48c is not just an integer multiple of the pitch width of the lenticular lens, uniformity of the lens pitch can be maintained in an excellent manner.

1. An apparatus for preparing a lenticular sheet comprising:
a photoconductor;
a light emitting section for forming an electrostatic latent image on the photoconductor;
a developing section for forming a transparent toner layer by applying a transparent toner to the electrostatic latent image on the photoconductor;
a transferring section for transferring the transparent toner layer on a transparent sheet; and
a lens forming section for forming a lenticular lens by molding and fixing the transferred transparent toner layer on the transparent sheet.

2. The apparatus according to claim 1, wherein the lens forming section comprises a lens forming roller heated by an internal heater, the lens forming roller rotating about an axis thereof, and a pressure roller disposed to face the lens forming roller to pressurize the lens forming roller,
the lens forming roller includes a plurality of grooves formed on an outer circumferential surface thereof at a prescribed pitch,
the pressure roller and the lens forming roller form a nip portion therebetween,
the transparent sheet is fed to the nip portion, and
the lens forming roller successively presses the transparent toner layer with the outer circumferential surface and brings about a heat deformation to form the lenticular lens.

3. The apparatus according to claim 1, wherein the lens forming section comprises a belt support member with a heater, a belt support roller, a lens forming belt movably suspended between the belt support member and the belt support roller, the lens forming belt heated by the heater, and a pressure roller disposed to face the belt support roller through the lens forming belt,
the lens forming belt includes a plurality of grooves formed on an outer circumferential surface thereof at a prescribed pitch,
the pressure roller pressurizes the belt support roller,
the pressure roller and the belt support roller form a nip portion therebetween,
the transparent sheet is fed to the nip portion, and
the lens forming belt successively presses the transparent toner layer with the outer circumferential surface and brings about a heat deformation to form the lenticular lens.

4. The apparatus according to claim 1, wherein the light emitting section is configured to form the electrostatic latent image having a size corresponding to a size of the transparent sheet on the photoconductor.

5. The apparatus according to claim 2, wherein the grooves are formed along a feed direction of the transparent sheet.

6. The apparatus according to claim 2, wherein the grooves are formed across a feed direction of the transparent sheet.

7. The apparatus according to claim 2, wherein the transparent toner contains a mold release agent for preventing adherence to the outer circumferential surface.

8. The apparatus according to claim 2, wherein the outer circumferential surface includes a release layer for preventing adherence of the transparent toner thereto.

9. The apparatus according to claim 2 further comprising a cleaning section including a heat resistant web, a web feed roller around which the web is wound and retained, a web press roller disposed to face the lens forming roller through the web, and a web wind roller for winding up the web fed from the web press roller,
wherein the cleaning section causes the web to press and slide against the outer circumferential surface of the lens forming roller to remove the transparent toner adhered thereto, and
the web press roller has a surface of a shape conforming to the grooves.

10. A method for preparing a lenticular sheet comprising the steps of:
forming an electrostatic latent image on a photoconductor;
forming a transparent toner layer by applying a transparent toner to the electrostatic latent image on the photoconductor;
transferring the transparent toner layer on a transparent sheet; and
forming a lenticular lens by molding and fixing the transferred transparent toner layer on the transparent sheet.

11. The method according to claim 10, wherein the step for forming a lenticular lens is accomplished by a lens forming section comprising a lens forming roller heated by an internal heater, the lens forming roller rotating about an axis thereof, and a pressure roller disposed to face the lens forming roller to pressurize the lens forming roller,
the lens forming roller includes a plurality of grooves formed on an outer circumferential surface thereof at a prescribed pitch,
the pressure roller and the lens forming roller form a nip portion therebetween,
the transparent sheet is fed to the nip portion, and
the lens forming roller successively presses the transparent toner layer with the outer circumferential surface and brings about a heat deformation to form the lenticular lens.

12. The method according to claim 10, wherein the lens forming step is accomplished by a lens forming section comprising a belt support member with a heater, a belt support roller, a lens forming belt movably suspended between the belt support member and the belt support roller, the lens forming belt heated by the heater, and a pressure roller disposed to face the belt support roller through the lens forming belt,
the lens forming belt includes a plurality of grooves formed on an outer circumferential surface thereof at a prescribed pitch,
the pressure roller pressurizes the belt support roller,
the pressure roller and the belt support roller form a nip portion therebetween,
the transparent sheet is fed to the nip portion, and
the lens forming belt successively presses the transparent toner layer with the outer circumferential surface and brings about a heat deformation to form the lenticular lens.
